(19) United States
(12) Patent Application Publication
(10) Pub. No.: US 2021/0090084 A1
(43) Pub. Date: Mar. 25, 2021

(54) SYSTEMS AND METHODS FOR TRACKING AND LOCATING TRANSACTION CARDS

(71) Applicant: Wells Fargo Bank, N.A., San Francisco, CA (US)

(72) Inventors: Jennifer A. Fisher, St. Louis, MO (US); Lynne Kenny, Walnut Creek, CA (US); Jesse F. Lee, Dublin, CA (US); Carola K. Neumann, San Francisco, CA (US)

(21) Appl. No.: 15/372,669

(22) Filed: Dec. 8, 2016

Related U.S. Application Data
(60) Provisional application No. 62/271,601, filed on Dec. 28, 2015.

(51) Int. Cl. G06Q 20/40; G07F 7/08; G06K 19/073; G06Q 20/34; G06Q 20/36

(52) U.S. Cl. CPC G06Q 20/4016; G07F 7/08; G06Q 20/409; G06Q 20/357; G06Q 20/36; G06K 19/07345

(57) ABSTRACT

Systems, methods, and apparatuses for tracking and monitoring a transaction card are provided. A method includes receiving a control parameter indicative of normal operation of a transaction card; acquiring operational data regarding operation and usage of the transaction card; comparing the operational data to the control parameter; responsive to the comparison, determining one of normal operation and non-normal operation of the transaction card; and, causing at least one response based on the determination, the at least one response structured to notify a user associated with the transaction card of the determination.

### CROSS-REFERENCE TO RELATED APPLICATIONS

This application claims the benefit of priority of U.S. Provisional Patent Application No. 62/271,601, entitled “SYSTEMS AND METHODS FOR TRACKING AND LOCATING TRANSACTION CARDS”, filed Dec. 28, 2015, which is incorporated by reference herein in its entirety.

### TECHNICAL FIELD

Embodiments of the present disclosure relate to tracking and locating transaction cards.

### BACKGROUND

Transaction cards are often used as payment vehicles in place of cash when engaging in financial transactions (e.g., purchasing a product). In this regard, transaction cards can include credit cards, debit cards, loyalty cards, and the like. To provide the payment, the transaction card includes one or more of a variety of types of payment technologies. One such common payment technology is the magnetic stripe. The magnetic stripe on the transaction card comprises magnetic particles that can be rearranged to store data (e.g., account holder's name, primary account number, etc.). A newer and another such payment technology is the EMV standard for transaction cards. The EMV standard for transaction cards, also referred to as chip cards, chip-and-pin cards, chip-and-signature cards, and smart cards, includes an integrated circuit or microprocessing chip embedded in the transaction card that is readable by a point-of-sale terminal to effectuate payment. The EMV standard includes additional protections against fraud that cause chip cards to be viewed as being more secure over the magnetic stripe technology. In addition to these payment technologies, a personal identification number (PIN) or signature may also be required for the transaction as authentication for the purchase. As can be seen above, transaction cards include varying levels of authentication/security that have become increasingly more heightened via the EMV standard in more recent times in order to prevent and mitigate fraud (e.g., the stealing of magnetic stripe data). Accordingly, fraud prevention and mitigation remains important to the field of transaction cards.

### SUMMARY

A first example embodiment relates to an apparatus. The apparatus includes a sensor circuit structured to receive initial operational data and subsequent operational data following the subsequent operational data, the initial and subsequent operational data indicative of operation of a transaction card; control parameter logic structured to determine a control parameter responsive to the initial operational data, the control parameter indicative of normal operation of the transaction card; a comparator circuit structured to compare the subsequent operational data to the control parameter, and responsive to the comparison, determine the subsequent operational data is indicative of one of normal operation of the transaction card and non-normal operation of the transaction card; and a notification circuit structured to provide one or more responses responsive to the determination.

Another example embodiment relates to a transaction card. The transaction card includes memory having instructions stored therein, and at least one processor structured to execute the instructions to: determine a control parameter, the control parameter indicative of normal operation of the transaction card; acquire operational data regarding operation of the transaction card; compare the operational data to the control parameter; responsive to the comparison, determine one of normal operation and non-normal operation of the transaction card; and selectively causing transmission of a notification to a mobile device of a user associated with the transaction responsive to the determination.

Another example embodiment relates to a method. The method includes receiving, by a transaction card, a control parameter indicative of normal operation of a transaction card; acquiring, by the transaction card, operational data regarding operation and usage of the transaction card; comparing, by the transaction card, the operational data to the control parameter; responsive to the comparison, determining, by the transaction card, one of normal operation and non-normal operation of the transaction card; and, causing, by the transaction card, at least one response based on the determination, the at least one response structured to notify a user associated with the transaction card of the determination.

These and other features, together with the organization and manner of operation thereof, will become apparent from the following detailed description when taken in conjunction with the accompanying drawings.

### BRIEF DESCRIPTION OF THE FIGURES

FIG. 1 is a diagram of a computing system, according to an example embodiment.

FIG. 2A is a back view of the transaction card of FIG. 1, according to an example embodiment.

FIG. 2B is a side view of the transaction card of FIG. 2A, according to an example embodiment.

FIG. 3 is a diagram of a card management system for a transaction card, according to an example embodiment.

FIG. 4 is a flow diagram of a method of tracking a transaction card via the card management system of FIGS. 1-3, according to an example embodiment.

### DETAILED DESCRIPTION

Referring to the Figures generally, systems, methods, and apparatuses for detecting and tracking a transaction card are provided according various embodiments herein. According to the present disclosure, a transaction card (e.g., a credit card, a debit card, etc.) may include one or more sensors operatively and communicably coupled to a card management system. The one or more sensors may include, but are not limited, a temperature sensor, a pressure sensor, a biometric sensor, an accelerometer, and the like. The card management system may be structured to receive and interpret data from the one or more sensors. Responsive to the interpretation of this data, the card management system may establish a baseline of data indicative of normal operation for the transaction card specific to the user associated with that transaction card. In other embodiments, the card management system may either come pre-programmed with the baseline data or be configurable by the user to set the baseline data. In these embodiments, the card management system may forego the initial tracking and interpretation of data process. Subsequent to an establishment of the baseline (referred to herein as the “control parameter”), the card management system may continuously or semi-continuously monitor the data from the one or more sensors. If the data is indicative of a deviation outside a predefined acceptable threshold (e.g., amount) from the baseline, the card management system may determine that such a deviation may be indicative of a missing transaction card and initiate one or more responses. One response may include generating and providing an alert to a mobile device of the user. Another such response may be disabling or modifying certain functions of the transaction card (e.g., lowering a spending limit, etc.). Still another such response may be alerting the issuing authority of the transaction card to cause cancellation of the transaction card and issuance of a new card. The type of response may be based on the gradation of deviation of the acquired data relative to the baseline or control parameter. However, if the data is indicative of normal operation (i.e., the data falls within the predefined acceptable range), the card management system may provide a message to a user associated with the transaction card to confirm the normal operation determination.

In addition to operation of the transaction card, the card management system may also receive inquiry requests from the user associated with the transaction card. One such inquiry request may include asking the current location of transaction card. Beneficially, the card management system may then return the location answer to the user to allow the user to relatively quickly locate the transaction card without, for example, having to re-trace their steps for a past amount of time while the transaction card was missing.

Beneficially, the systems, methods, and apparatuses provided herein may facilitate real-time tracking and monitoring of one's transaction cards with little to no input from the user. As an example, a user may inadvertently leave a transaction card at a merchant location. However, due to a location binding setting, the transaction card may be bound to the mobile device of the user. In this regard, if the transaction card is more than a predefined distance from the mobile device, the card management system may send a notification. Accordingly, based on the user leaving the merchant location, the card management system may transmit the notification to the mobile device in an effort to cause the user to return to the merchant location. If the user does not return to the merchant location or affirmatively acknowledge the notification, the card management system may take a subsequent action (e.g., cancelling the card, limiting functionality of the card, alerting the issuer of the transaction card, etc.). As such and advantageously, the card management system may effectively manage the functions of the transaction card to reduce potentially fraudulent activity (e.g., another person taking the transaction card and then using that card) and mitigate the effects of a lost or missing transaction card (e.g., provide a notification indicating the location of the transaction card, reduce spending limit, etc.). In this regard, users may achieve a relatively greater peace of mind with respect to their transaction cards knowing that even in a misplaced situation, the card management system provides the user with security. These and other features of the present disclosure are described more fully herein below.

As used herein, the phrase “transaction card” is meant to be broadly defined and generally refer to any type of transaction card used to effectuate purchases. Accordingly, a “transaction card” may include, but is not limited to, a credit card, a debit card, a loyalty card, a rewards card, and so on. In this regard, the transaction card may include any type of payment technology including the magnetic stripe payment technology and/or the EMV payment technology. Accordingly, those of ordinary skill in the art will appreciate that a transaction card can be used for a variety of purchases and transactions.

As also used herein, the phrase “normal operation” as it relates to operation and usage of the transaction card is meant to be broadly interpreted and generally refer to activity of the transaction card that appears normal, expected, etc. For example, consistent transaction amounts at the same locations may indicate normal operation. As another example, consistent traveling of the transaction card within a certain area may also indicate normal operation (e.g., use of the transaction card near one's home and one's work locations). In comparison and as used herein, the phrase “non-normal operation” refers to operation and usage of the transaction card that appears to be out-of-pattern, not normal, unexpected, etc. for the particular user associate with the transaction card. For example, if the user lives in California, but transactions have been performed on the card in Maine for the past two weeks, such activity may be indicative of non-normal operation. In this regard, non-normal operation may include operation and usage indicating any of a missing transaction card, a lost transaction card, and a stolen transaction card.

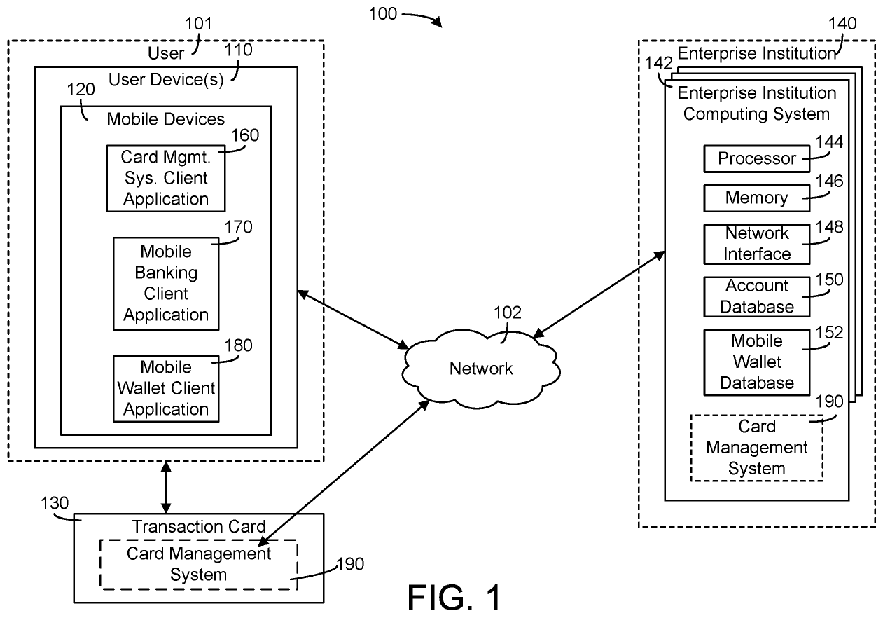

Referring now to FIG. 1, a diagram of a computing system 100 is shown according to an example embodiment. As described herein, the computing system 100 may facilitate the detection, monitoring, and tracking of transaction card(s). As shown, the computing system 100 includes one or more user devices 110 associated with a user 101, one or more transaction cards 130 having a card management system 190, and one or more enterprise institutions 140 associated with an enterprise computing system 142. The components of FIG. 1 may be communicably and operatively coupled to each other over a network 102. The network 102 may be any type of type of network. For example, the network 102 may be a wireless network interface (e.g., 802.11X, ZigBee, Bluetooth, Internet, etc.), a wired network interface (e.g., Ethernet), or any combination thereof. The network 102 is structured to permit the exchange of data, values, instructions, messages, and the like between and among the user device 110, transaction card 130, and the enterprise computing system 142.

As shown, the enterprise institution 140 includes an enterprise computing system 142. The enterprise institution 140 may be any type of enterprise institution associated with the transaction card 130. Accordingly, the enterprise institution 140 may include a financial institution (e.g., a bank), a credit card issuing company, and any other entity associated with and/or supporting the activities of the transaction card 130. Accordingly, each transaction card 130 may be associated with a different enterprise computing system 142. As shown, the enterprise computing system 142 includes a processor 144, a memory device 146, a network interface 148, an account database 150, a mobile wallet database 152, and in some embodiments, the card management system 190.

The processor 144 may be implemented as a general-purpose processor, an application specific integrated circuit (ASIC), one or more field programmable gate arrays (FPGAs), a digital signal processor (DSP), a group of processors, or other suitable electronic processing components. The one or more memory devices 146 (e.g., RAM, ROM, NVRAM, Flash Memory, hard disk storage, etc.) may store data and/or computer code for facilitating at least some of the various processes described herein. In this regard, the memory 146 may store programming logic that, when executed by the processor 144, control the operation of the enterprise computing system 142. The network interface 148 may facilitate the sending and receiving of data over the network 102 (e.g., to and from the user device 110, etc.). The account database 150 may store customer information and account information relating to accounts held with the enterprise institution 140 of the user (e.g., a checking account). In this regard and as mentioned above, more than one enterprise institution 140 with an associated enterprise institution computing system 142 may be communicably coupled to the components of FIG. 1 over the network 102 to account for accounts held by the user by two or more different enterprise institutions. As further shown, the mobile wallets account database 152 for storing mobile wallet accounts of users. As described herein below, the mobile wallet accounts may permit payments via the mobile wallet client application 180.

As shown, the user 101 may have or be associated with a user device 110. The user 101 may include individuals, business representatives, and any other entity that may own or be associated with a transaction card 130. In some configurations, the user 101 may have a financial account at one or more of the enterprise institutions 140 of the system 100.

The user device 110 may be generally described as a mobile device 120. The mobile device 120 may include any wearable device. Wearable devices refer to any type of device that a user wears including, but not limited to, a watch (e.g., a smart watch), glasses (e.g., eye glasses, sun glasses, smart glasses, etc.), bracelet (e.g., a smart bracelet), etc. Mobile devices 120 may also include any type of mobile device of a user 101 including, but not limited to, a phone (e.g., a smartphone, etc.) and a computing device (e.g., a tablet computer, a laptop computer, a person digital assistant, etc.). Accordingly, the user device 110 may include a display device (e.g., a screen) and one or more input/output devices (e.g., a touch screen, microphone, speaker, keyboard, etc.).

In this example, the user device 110 includes a card management system client application 160, a mobile banking client application 170, and a mobile wallet client application 180. The card management system client application 160, mobile banking client application 170, and/or mobile wallet client application 180 may be server-based applications executable on the user device 110. In this regard, a user may have to first download the application(s) prior to their usage. In another embodiment, the card management system client application 160, mobile banking client application 170, and/or mobile wallet client application 180 may be hard coded into the memory of the user device 110. In still another embodiment, the card management system client application 160, mobile banking client application 170, and/or mobile wallet client application 180 may be web-based interface applications. In this configuration, the user may have to log onto or access the web-based interface before usage of the application(s). In this regard, at least one of the card management system client application 160, mobile banking client application 170, and mobile wallet client application 180 may be supported by a separate computing system comprising one or more servers, processors, network interface modules, etc. that transmit the applications for use to the user device 110. In certain embodiments, the card management system client application 160, mobile banking client application 170, and/or mobile wallet client application 180 may include an application programming interface (API) and/or a software development kit (SDK) that facilitate the integration of other applications with at least one of the card management system client application 160, mobile banking client application 170, and mobile wallet client application 180. All such variations and combinations are intended to fall within the spirit and scope of the present disclosure.

The mobile banking client application 170 may be communicably coupled to the enterprise computing system 142 (e.g., the accounts database 150) via the network 102 and may be structured to permit management of the user's accounts via the mobile banking client application 170. In this regard, the mobile banking client application 170 may provide displays indicative of current account balances, pending transactions, profile information (e.g., contact information), and the like. Further, in some embodiments, the mobile banking client application 170 may also permit payments from the user 101 to a designated recipient. For example, the mobile banking client application 170 may depict a loan of a user (e.g., mortgage) and allow the user to pay the mortgage from one of their accounts (e.g., checking or savings). In another example, a bill pay option may be provided by the mobile banking client application 170, where the bill pay option allows the user 101 to pay his/her bills.

The mobile wallet client application 180 may be communicably coupled to the enterprise institution computing system 142 (e.g., the mobile wallets database 152) via the network 102 and may be structured to facilitate purchases by the user via the mobile wallet client application 180. Accordingly, the mobile wallet client application 180 may be linked or otherwise connected with one or more accounts of the user. In operation, when at a point-of-sale terminal, a user may open the mobile wallet client application 180 and provide a passcode (e.g., biometrics such as a thumbprint, a personal identification number (PIN), a password, etc.) to authenticate the person and select the source payment account desired (e.g., a checking account from a particular financial institution that is linked to the mobile wallet client application 180). Via communication with the payment terminal (e.g., via near field communication, QR code scanning, etc.), the aforementioned payment information may be provided and the payment processed. Beneficially, carrying payment cards may be avoided or reduced via the mobile wallet client application 180.

As shown, the card management system client application 160 may be embodied with the user device 110 and structured as a thin client application that is executable by a processor of the user device 110. Accordingly, the card management system client application 160 may support a graphical user interface that communicably couples the card management system 190 to the user device 110. In this regard and as described herein below, the user 101 may provide information, data, values, commands, and the like to the card management system 190 for execution. For example, via the card management system client application 160, the user 101 may define certain control parameters that define normal operation/behavior of or associated with the transaction card 130 that enable the card management system 190 to determine non-normal transaction card situations based on the control parameters. For example and as described below, via the card management system client application 160, the user 101 may define a pattern of normal operation and usage of the transaction card (e.g., where it is used, how often, typical transaction amounts, etc.). As another example, via the card management system client application 160, the user 101 may define one or more responses of the card management system 160 that are actuated responsive to determining that the transaction card 130 may be missing or lost (e.g., send an alert to the mobile device 120, deactivate certain functions of the transaction card 130, etc.). Accordingly, via the card management system client application 160, the user 101 may define certain operations of the card management system 190.

As alluded to above, via the card management system client application 160, the user 101 may define a control parameter and/or normal operation and usage of the transaction card 130 (i.e., normal patterns). In this regard, before the card is lost or missing, the user can set up a profile for themselves to help configure how the comparator circuit 316 (described below) determines whether the card has been lost or stolen. In practice, via the card management system client application 160, the user may be presented with a series of questions that may be used to elicit information configured to determine patterns for that user 101. Based on the answers, the sensors 230 included with the card 130 may be structured to selectively acquire data that is related to the elicited information to aid/allow the comparator circuit 316 to determine normal operation or non-normal operation of the card 130. Example questions that the user may be presented with include the following, wherein the top bullet refers to which sensor the answers to the questions might impact in order to analyze typical usage patterns:

For the accelerometer:
Do you typically carry your credit card (i.e., the transaction card 130) to work every day? Yes or no?
Do you work at the same location every day? Yes or no?
Do you ride an elevator? Yes or no?

For the temperature sensor:
Do you routinely keep the card in a wallet on your person? Yes or no?
   As those of ordinary skill in the art will appreciate, the number, quantity, and specifics of each question for a variety of sensors may be vary greatly with all such variations intended to fall within the scope of the present disclosure. Based on the user's answers, the card management system 190 may decide what patterns to expect, and what things might be determined to be deviations from those expected patterns. In other embodiments and as described below, automatic or mostly automatic pattern analysis may be used to determinate deviations from normal behavior (e.g., by monitoring the tracked data to determine normal operation and usage). That is to say, the above example describes an example using initial user inputs while the example described herein below is based on mostly on pattern recognition that may be largely without user input. However, in yet other embodiments, a combination of user-input and pattern recognition/analysis may be used to determine subsequent out-of-pattern or non-normal operation and usage of the transaction card 130.

In one embodiment, the card management system client application 160 may be included with the mobile wallet client application 180. In this instance, the user may beneficially observe all of their transaction cards loaded into the mobile wallet as well as the transaction cards that have the structure and function described herein below. Further, via the mobile wallet client application 180, the user 101 may provide the same or similar types of information as described above.

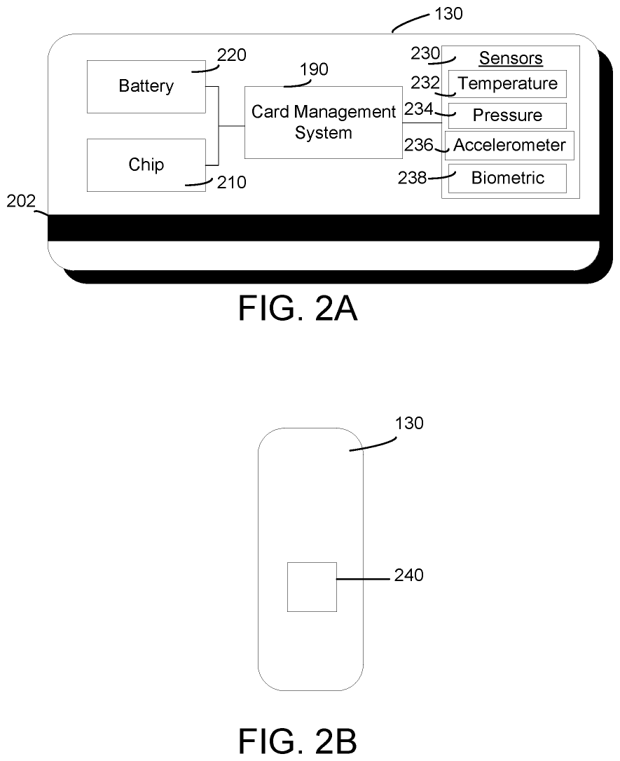

As described herein, the card management system 190 may be structured to track and monitor the activity of the transaction card 130. Before turning to the structure and function of the card management system 190, the structure and function of the transaction card 130 is shown more fully in regard to FIGS. 2A-2B.

Accordingly, referring now to FIGS. 2A-2B, the function and structure of the transaction card 130 is shown, according to an example embodiment. As mentioned above, the transaction card 130 may include any type of transaction card used to effectuate purchases. Accordingly, the transaction card 130 may include, but is not limited to, a credit card, a debit card, a loyalty card, a rewards card, and so on. As shown, the transaction card 130 includes two payment or transaction devices, shown as a magnetic stripe payment device 202 and a chip 210, a battery 220, one or more sensors 230, and the card management system 190.

The magnetic stripe payment device 202 may be structured as any type of magnetic stripe payment device 202. In this regard, the magnetic stripe payment device 202 may be structured to carry Track 1, Track 2, and/or Track 3 data. In operation, the magnetic stripe payment device 202 may be swiped (e.g., slid) through a point-of-sale magnetic stripe card reader. The point-of-sale card read may extract the data contained in the magnetic stripe payment device 202 (e.g., account number, expiration date, card type, service code, any discretionary data, etc.). Based on the extracted data, the point-of-sale card reader may facilitate a payment transfer.

The chip 210 may be structured as the micro-processing chip used with the EMV technical standard. Accordingly, like the magnetic stripe payment device 202, the chip 210 may store data to facilitate payment using the transaction card 130. As such, the chip 210 may contain the same type of data; and, in some instances, even a greater amount of data due to the memory capacity in the chip 210 exceeding that of the magnetic stripe payment device 202. In operation, payment via the chip 210 may be accomplished via “card dipping” (i.e., inserting the transaction card 130 in a terminal slot of the point-of-sale card reader to allow data exchange between the terminal and the card and, in certain arrangements, to charge the chip 210 for future transactions) or a contactless transaction (e.g., via near-field communication when the transaction card 130 is within a certain proximity to the point-of-sale terminal). In this regard, the chip 210 provides a multi-interface card in the form of: i) a contact-based card via “card dipping” and ii) a contact-less card via a wireless protocol, such as near-field communication. Beneficially and relative to the magnetic stripe payment device 202, the chip 210 may mitigate fraudulent activity by reducing the possibility of copying the transaction card 130 and facilitating relatively more secure transactions.

It should be understood that the inclusion of both the chip 210 and magnetic stripe payment device 202 with the transaction card 130 is for illustrative purposes only. In other embodiments, only one of the devices 210, 220 may be included with the transaction card. All such variations are intended to fall within the scope of the present disclosure.

In this example, the transaction card 130 is shown to include a battery 220. The battery 220 may be structured to provide electrical power to one or more components of the card 130, such as one or more of the sensors 230. In this regard, the battery 220 may be communicably and electrically coupled to the card management system 190 and to any of the components included with the transaction card 130. According to an alternate embodiment, the battery 220 may be excluded from the transaction card 130. In this configuration, the components that require or may require electrical power may include a charging circuit that stores electrical energy as provided via the port 240. Accordingly, when power decreases below a threshold, the transaction card 130 may need to be charged via the port 240 and an electrical power source (e.g., an outlet). Based on the foregoing, the battery 220 may include a single battery or multiple batteries. Further, the battery 220 may include either non-rechargeable (i.e., primary) or rechargeable (i.e., secondary) batteries. Examples of a type of battery that the battery 220 may include capacitors, lithium type batteries (e.g., lithium-ion batteries), nickel type batteries (e.g., NiMH battery), other button cells (e.g., silver oxide and alkaline cells), and so on. It should be understood that the aforementioned list of batteries is not meant to be exhaustive as the present disclosure contemplates other and different types of batteries that are intended to fall within the scope of the present disclosure.

The sensors 230 may be structured to acquire data indicative of operation and usage of the transaction card 130. In one embodiment, the sensors 230 may be communicably and operatively coupled to the card management system 190 to provide the acquired data to the card management system 190. In another embodiment, one or more of the sensors 230 may be included with the card management system 190.

As mentioned above, the sensors 230 may be structured to acquire data indicative of operation and usage of the transaction card 130. Operation and usage (referred to herein as “operational data”) of the transaction card 130 may include transaction data indicative of: locations where transactions are effectuated (e.g., various gas stations, grocery stores, other merchant locations); transaction dollar amounts at each of the locations where transactions are effectuated; time of day and/or calendar time of the year when various transactions are effectuated; and/or any other type of data relating to the transactions effectuated by the transaction card 130.

Operational data of the transaction card 130 may also include data indicative of how the transaction card 130 is handled by the user 101. In this regard, the sensor 230 block is shown to include a temperature sensor 232, a pressure sensor 234, an accelerometer 236, and a biometric sensor 238. It should be understood that other embodiments may include more, less, or different sensor types than that shown in FIG. 2A.

The temperature sensor 232 may be structured as any type of temperature sensor (e.g., thermocouple, thermistor, etc.) and structured to acquire data indicative of a temperature of the transaction card 130. In another embodiment, the temperature sensor 232 may acquire data indicative of a temperature in the environment surrounding the transaction card 130 (e.g., in or around the wallet that holds the transaction card 130). In yet another embodiment, the temperature sensor 230 may be structured to acquire data indicative of a temperature of both a temperature on the card and a temperature surrounding the card 130. In this regard, the temperature sensor 232 may acquire temperature data indicative of when certain temperatures or ranges thereof are experienced by the card 130, such that the card management system 190 may determine one or more temperature control parameters indicative of a normal temperature on or near the card 130 for the user 101 at certain times and locations. For example, the user may commute to work and the transaction card 130 is stored in the user's back pocket. As a result of sitting in their back pocket for the commute, the temperature data during the commute times may be relatively higher than at other times (e.g., around one-hundred and one (101) degrees Fahrenheit). Accordingly and as described herein below, the card management system 190 may determine a temperature control parameter of approximately 101 degrees Fahrenheit during the commuting times for the user.

The pressure sensor 234 may be any type of pressure sensor (e.g., strain gauge, capacitive, electromagnetic, piezoelectric, etc.) and structured to acquire data indicative of a pressure on the transaction card 130. In this regard, the pressure sensor 234 may acquire pressure data indicative of when certain pressures or ranges thereof are applied to the card 130, such that card management system 190 may determine a pressure control parameter indicative of a normal pressure on the card 130 for the user at certain times and locations in a similar manner as described above in regard to the temperature control parameter.

The accelerometer 236 may be structured as any type of acceleration measuring or estimating device that may be structured to acquire data indicative of an acceleration characteristic of the transaction card 130. For example, the acceleration characteristic may be indicative of a drop of the transaction card 130 at an elevated height (e.g., above twenty feet). In a similar manner as mentioned above in regard to the temperature control parameter, the card management system 190 may determine an acceleration control parameter indicative of normal acceleration characteristics experienced by the card 130 of the user 101.

The biometric sensor 238 may be structured as any type of biometric sensor including, but not limited to, a fingerprint scanner, voice recognition scanner, and so on. The biometric sensor 238 may be structured to authorize use of the card 130 based on authentication of the biometric characteristic (e.g., a matching fingerprint). In this regard, the card management system 190 may receive data indicative of biometrics of users handling the transaction card 130, compare the received data to stored control parameters (e.g., to biometrics of users authorized to handle or use the card 130), to determine if a potential lost or stolen card 130 situation exists (i.e., non-normal operation).

Accordingly and as alluded to above, the card management system 190 may receive data from one or more of the sensors 130 to determine a control parameter for each data point (e.g., acquired or received temperature data may be used to generated a temperature control parameter, acquired or received pressure data may be used to generate a pressure control parameter, acquired or received biometric data may be used to generate a biometric control parameter, acquired or received transaction data may be used to generate a transaction control parameter, etc.). The card management system 190 may then compare subsequently received or acquired operational data to determine non-normal operation and/or usage of the card 130 and cause one or more responses, which are described in more detail below.

Referring in more detail now to FIG. 2B, a port 240 is disposed or positioned on a side of the transaction card 130. In other embodiments, the port 240 may be positioned anywhere on the transaction card 130. The port 240 may be structured to at enable a wired connection (e.g., via USB cable) to a mobile device 120 and/or external power source for charging the battery 220. While the transaction card 130 may communicate with the mobile device 120 via a wireless protocol (e.g., Bluetooth), in other situations, the communication may be via a wired protocol using the port 240. Accordingly, the port 240 may include, but is not limited to, any type of universal serial bus (USB) (e.g., micro, mini, etc.), an audio jack type port, an HDMI port, any type of Apple adaptor (e.g., 9 pin), and the like. In this regard, while only one port 240 is shown in FIG. 2B, it should be understood that several ports of any type may be included with the transaction card 130.

In another embodiment, the battery 220 and/or other components may be wirelessly charged (e.g., via induction). In this regard, the size of the card 130 may be the same or substantially the same as a typical transaction card. Accordingly, wireless charging or powering may be used with the transaction card 130. In yet another embodiment, the battery 220 and/or any other components may be charged or receive power from the chip 220 (e.g., the EMV standard) when the card is dipped. Accordingly, as those of ordinary skill in the art will appreciated, power may be provided to the card 130 for charging one or more components via a variety of mechanisms and methodologies with all such varieties intended to fall within the scope of the present disclosure.

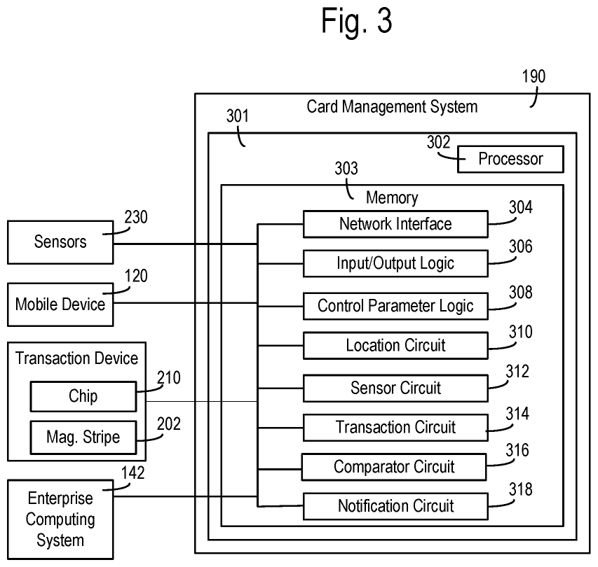

Referring now to FIG. 3, the structure and function of the card management system 190 is illustrated, according to one embodiment. In this example embodiment, the card management system 190 is embodied in the transaction card 130 like shown in FIGS. 1-2B. However, in other embodiments, the card management system 190 may be embodied in a central computing system associated with the transaction card 130, such as the enterprise computer system 142. In this latter configuration, the sensors 230 may transmit, via the network interface 304 (see FIG. 3), to the card management system 190, wherein the card management system 190 may perform the operations described herein below at the enterprise computing system 142 location. Beneficially, this arrangement may be used to decrease the number of components included with the transaction card 130 to make the transaction card 130 have a similar structure to typical chip and/or magnetic stripe transaction cards. Accordingly, the description contained herein below with the card management system 190 embodied in the transaction card 130 is not meant to be limiting.

As shown, the card management system 190 includes a processing circuit 301 having a processor 302 and a memory 303. The processor 302 may be implemented as a general-purpose processor, an application specific integrated circuit (ASIC), one or more field programmable gate arrays (FPGAs), a digital signal processor (DSP), a group of processing components (e.g., processors) that may be distributed over various geographic locations or housed in a single location, or other suitable electronic processing components. The one or more memory devices 303 (e.g., RAM, NVRAM, ROM, Flash Memory, hard disk storage, etc.) may store data and/or computer code for facilitating the various processes described herein. Moreover, the one or more memory devices 203 may be or include tangible, non-transient volatile memory or non-volatile memory. Accordingly, the one or more memory devices 303 may include database components, object code components, script components, or any other type of information structure for supporting the various activities and information structures described herein.

The card management system 190 is shown to include various circuits and logic for completing at least some of the activities described herein. More particularly, the card management system 190 includes a network interface 304, input/output logic 306, control parameter logic 308, a location circuit 310, a sensor circuit 312, a transaction circuit 314, a comparator circuit 316, and a notification circuit 318. While various circuits, interfaces, and logic with particular functionality are shown in FIG. 3, it should be understood that the card management system 190 may include any number of circuits, interfaces, and logic for completing the functions described herein. For example, the activities of multiple circuits may be combined as a single circuit, as additional circuits with additional functionality may be included, etc.

The network interface 304 may be any type of network interface for communicating with internal components of the card 130 (e.g., the transaction device 202) and external components relative to the card 130 (e.g., mobile device 120, enterprise computing system 142, etc.). Accordingly, the network interface 304 may include any of a cellular transceiver (e.g., CDMA, GSM, LTE, etc.), a wireless network transceiver (e.g., 802.11X, ZigBee, Bluetooth, etc.), a wired network interface (e.g., Ethernet that may be used via the port 240), or a combination thereof (e.g., both a cellular transceiver and a Bluetooth transceiver). Further, the network interface 304 may include cryptography capabilities to establish a secure or relatively secure communication session with the at least one enterprise computing system 142 or another device of the user's choosing (e.g., the mobile device 120). In this regard, data may be encrypted to prevent or substantially prevent the threat of hacking.

The input/output logic 306 may be communicably coupled to the card management system client application 160 and the enterprise computing system 142 to enable reception of data, values, messages, and the like from a user or attendant of at least one of the client application 160 and computing system 142. One such input may include a control parameter at a certain location and time for the transaction card 130. As mentioned above and as used herein, the phrase “control parameter” refers to data indicative of normal operation and usage of the transaction card 130. Accordingly, the control parameter may include, but is not limited to, a temperature control parameter, a pressure control parameter, an acceleration control parameter, a biometric control parameter, and so on at certain times and locations. Another such input may include an object binding input and a geographical area binding input. The object binding input may define a predefined object (e.g., mobile device 120) and a maximum allowable distance from the predefined object. In this regard, the transaction card 130 may be “tied” to the predefined object, such that if the transaction card or object is moved outside of the maximum allowable distance, the notification circuit 318 may provide one or more notifications. In comparison, the geographical area binding input may define an acceptable area for the transaction card 130 (i.e., not tied to a particular object), such that if the transaction card 130 ventures outside of the geographical area, the notification circuit 318 may provide a notification (or other suitable response) to the user.

Further, as described below, the input/output logic 306 may also provide information regarding the control parameters and operational data acquired, such that the user may view and modify such information. Further, via the input/output logic 306, the user may provide information confirming or denying normal or non-normal operation of the transaction card 130. As such, the input/output logic 306 may facilitate and provide the exchange of communications with the card management system 190.

The control parameter logic 308 may be structured to at least one of receive and determine a control parameter indicative of normal or predefined acceptable operation and usage of the transaction card 130. In the alternative, the control parameter logic 308 may be structured to at least one of receive and determine a control parameter indicative of non-normal operation and usage of the transaction card 130. Unless described in regard to the alternate embodiment mentioned above and as otherwise mentioned herein, the “control parameter” refers to data, values, etc. that indicate normal operation and usage of the transaction card 130 for the particular user 101 of the card 101. According to one embodiment, the control parameter logic 308 includes communication circuitry that facilitate the reception of data, values, and the like from at least one of the card management system client application 160 running on the mobile device 120, the input/output logic 306, the sensor circuit 312, the transaction circuit 314, and the enterprise computing system 142. In this regard and as mentioned above, a user may, via the client application 160, or an entity via the enterprise computing system 142 may predefine or adjust a predefined one or more control parameters. In another embodiment, the control parameter logic 308 may include machine-readable media stored by the memory 303 and executable by the processor 302 to facilitate the reception or determination of control parameters.

As mentioned above, the control parameter includes data indicative of normal operation and usage of the transaction card 130. The control parameter(s) may be determined based on operational data regarding operation of the transaction card 130. In this regard, the operational data may include, but is not limited to, transaction data and other operational data, which is described herein as temperature data, pressure data, biometric data, and acceleration data. However, this list of operational data is not meant to be limiting as the present disclosure contemplates more, different, and other types of operational data that may be received and/or acquired regarding operation of the transaction card 130. The operational data may be at least one of acquired and received to determine the control parameter(s). Accordingly, the operational data may include any one or more of the following: temperature data at various times and locations; pressure data at various times and location; biometric data corresponding to authorized or allowed users of the transaction card 130; location data (e.g., a current or previous location of the transaction card 130); transaction data at various times and locations; etc. Beneficially, using acquired operational data tailors the control parameter determination to a specific user of the transaction card. In this regard, the systems and methods described herein may facilitate relatively more accurate determinations of normal and non-normal operation for each user having the transaction card 130.

Based on the operational and transaction data, the control parameter logic 308 may be structured to at least one of receive or determine one or more control parameters at various times and locations. In regard to receiving, one or more control parameters may be predefined in the card management system 190. However, in regard to determine the one or more control parameters, this determination may be accomplished using any one or more statistical algorithms, formulas, processes, models, and the like. Examples may be described as follows.

In regard to the temperature control parameter, the control parameter logic 308 may continuously or periodically receive temperature data for a predefined period of time. At which point, the control parameter logic 308 may determine a typical temperature experienced by the card 130 at various times and locations. For example, the transaction card 130 may be stored in a wallet of the user, where that user typically stores the wallet in their back pocket. During morning and evening times of the work week, an elevated temperature data set may be acquired based on the user sitting on their back pocket while driving home from work. Accordingly, during the work week at mornings and evenings, the control parameter logic 308 may determine that elevated temperature or elevated temperature range based on a predetermined median or average temperature during that time to be normal and, as such, the temperature control parameter for those days/times. Of course, similar processes may be used during other periods of the day to determine temperature control parameters at those times and locations.

In regard to the pressure control parameter, the control parameter logic 308 may continuously or periodically receive pressure data for a predefined period of time or, using a statistical algorithm, until a confidence interval is at or above a predefined threshold to determine the pressure control parameter. At which point, the control parameter logic 308 may determine a typical or normal pressure experienced by the card 130 at various times and locations. For example, during transactions (which may be determined by the transaction circuit 314 or location data from the location circuit 310), a relatively larger pressure may be applied to the transaction card 130 by the user as the user removes the transaction card from a wallet storing the transaction card 130. Accordingly, based on location data from the location circuit, the control parameter logic 308 may determine that the user 101 is at a merchant location and expect to experience the normal pressure (i.e., pressure control parameter) that the user 101 seems to typically apply to the card 130 when pulling it from the wallet and using it at various merchant locations.

In regard to the temperature control parameter and pressure control parameter, the control parameter logic 308 may use any value at a particular time and location to be the temperature control parameter and pressure control parameter. For example, the value may be a range of values. In another example, the value may be a discrete value, wherein the discrete value may include any of an average value, a median value, or another statistical value. Accordingly, those of ordinary skill in the art will appreciate that many different processes may be used to determine various control parameters and, in particular, temperature and pressure control parameters.

In regard to the biometric control parameter, the control parameter logic 308 may, via the notification circuit 318, provide a prompt to the user 101 to provide biometric information using the card management system client application 160. Additionally or alternatively, the control parameter logic 308 may receive biometric data directly from the transaction card 130 (e.g., via a fingerprint scanner) to determine normal biometrics regarding usage of the transaction card 130 (i.e., the biometric control parameter). Accordingly, the biometric control parameter may include, but is not limited to, a fingerprint biometric control parameter and the like. As an example, if an unrecognized fingerprint is repeatedly detected on the transaction card for an extended period of time (i.e., to avoid false positives when a merchant may momentarily take the transaction card), a notification may be transmitted to the mobile device 120 to alert the user of such activity.

In regard to acceleration control parameters and/or transaction control parameters, the control parameter logic 308 may receive data indicative of normal transactions and acceleration associated with the transaction card 130. For example, the user may work on the fortieth floor of an office building and gets to work Monday-Friday between 7am and 9am and leaves around 5pm. The acceleration control parameter on Monday-Friday at those times may be relatively greater than the acceleration control parameter at other times and days for the user. As another example, the user may always buy coffee at the same time and same location each week, wherein that particular time, location, and average (or another value) transaction value may be used as a transaction control parameter(s) for the transaction card 130.

Of course, in regard to any of the aforementioned control parameters, the control parameter logic 308 may utilize none, only one, or a plurality of control parameters at various times and locations to serve as a particular control parameter for the card management system 190. For example, reliable temperature data may only be acquired during 7am and 9am Monday-Friday, such that the temperature control parameter is only applicable during 7am and 9am Monday-Friday. Thus, the aforementioned list/description is not meant to be limiting as the present disclosure contemplates other and different methodologies used to determine one or more control parameters.

The location circuit 310 may be structured to receive location data and determine a location of the transaction card 130 based on the location data. In one embodiment, the location circuit 310 may include a global positioning system (GPS) or any other type of location positioning system. As such, the location circuit 310 may receive latitude data, longitude data, and any other type of location or position data to determine the location of the user device 110. In other embodiments, the location circuit 310 may receive location data from a user (e.g., via the mobile device 120) that indicates the location of the transaction card 130. For example, a user may utilize a graphical user interface generated and provided by the card management system client application 160 (see FIG. 1) to input various information for controlling the card management system 190, wherein such information may include a location identification of the transaction card 130. In still other embodiments, the location circuit 310 may receive an explicit location identification from an attendant of the enterprise computing system 142. All such variations are intended to fall within the spirit and scope of the present disclosure.

The sensor circuit 312 may be structured to receive data from a sensor 230. Accordingly, in one embodiment, the sensor circuit 312 may include the sensors 230 such that the sensor circuit 312 may directly control the frequency of acquisition of the data from each sensor included with the card 130. In another embodiment, the sensor circuit 312 and system 190 in general may be embodied as an integrated circuit or other microprocessing unit that is removably included with the card 130, such that the circuit 312 when inserted may be communicably and operatively coupled to each sensor of the sensors 230. At which point, the sensor circuit 312 may begin reception of the data. In yet another embodiment (e.g., when the system 190 is included with the enterprise computing system 142), the sensor circuit 312 may include machine-readable media that facilitate providing instructions to the card 130 to direct the card 130 to provide (at predefined frequencies or times) one or more pieces of the acquired data from one or more of the sensors 230. All such variations are intended to fall within the scope of the present disclosure.

Responsive to receiving the sensor data, the sensor circuit 312 may provide such data to the control parameter logic 308 where the control parameter logic 308 determines a control parameter associated with each sensor data (e.g., temperature control parameter, pressure control parameter, biometric control parameter, transaction control parameter).

The transaction circuit 314 may be structured to receive transaction data regarding a transaction effectuated by the transaction card 130. Accordingly, the transaction circuit 314 may be communicably coupled to the transaction or payment device (e.g., chip 210 and/or magnetic stripe 202). In one embodiment, the transaction circuit 314 may include the transaction device such that transaction data may be acquired at each transaction. For example, when the card management system 190 is included with the transaction card 130, the transaction device may be included with the transaction circuit 314. In another embodiment, the transaction circuit 314 may include communication circuitry that facilitate the exchange of information, data, values, and the like between the transaction circuit 314 and the transaction device. In yet another embodiment, the transaction circuit 314 may include machine-readable media stored by the memory 302 and executable processor 303 to provide a command or instruction to the transaction device to receive transaction data from the transaction device. In yet another embodiment, the transaction circuit 314 may include any combination of hardware components and machine-readable media.

As mentioned above, the transaction circuit 314 may receive transaction data regarding a transaction effectuated by the transaction card 130. Accordingly, the transaction data may include, but is not limited to, a quantity of transactions per predefined timed period (e.g., daily), a merchant category code, a transaction amount, a date of purchase, a merchant location, whether the purchase was effected as a credit transaction or a debit transaction, and other data regarding the specific transaction. In some embodiments, one or more pieces of transaction data may be subject to a privacy setting as prescribed by a card company that supports the transaction card 130. As such, the transaction data may vary from embodiment-to-embodiment.

According to another embodiment, the transaction circuit 314 may receive the transaction data explicitly from the user 101 via the card management system client application 160 and input/output logic 306. In yet another embodiment, the user 101 may authorize the transaction circuit 314 to communicate over a network, such as the Internet, to acquire or receive the transaction data from a website associated with the issued card company (e.g., via online banking). As such, while the transaction circuit 314 is primarily described herein as receiving transaction data from the transaction device, this configuration is exemplary only and not meant to be limiting.

The comparator circuit 316 may be structured to receive the control parameter from the control parameter logic 308 and compare the control parameter(s) to subsequent operational data regarding the transaction card 130 (e.g., transaction data and operational data from the sensor circuit 314 such as temperature, pressure, biometric, and acceleration data). Responsive to the comparison, the comparator circuit 316 may determine whether the operational data is indicative of normal or acceptable operation of the transactional card 130 or indicative of non-normal operation such as a lost, missing, and/or stolen circumstance. The comparator circuit 316 may provide the comparison to the notification circuit 318 to provide one or more notifications responsive to comparison.

As alluded to above, the comparator circuit 316 may determine normal operation or that potentially non-normal operation exists based on a comparison between one or more pieces of operational data (e.g., temperature data, pressure data, etc.) and one or more pieces of control parameters (e.g., temperature control parameter). The determination that normal operation exists may be based on one or more pieces of operational data falling within predefined range of the corresponding control parameter. In this regard, the predefined range may be the same or different for each control parameter. As an example, the control parameter may be seventy (70) degrees Fahrenheit during the day (e.g., 9am-5pm) on Monday-Friday with a predefined acceptable range of plus-or-minus five (10) degrees Fahrenheit. As another example, the control parameter may prescribe an absolute minimum or maximum value for an associated piece(s) of operational data. For example, the operational data may indicate that the highest acceleration experienced by the transaction card for the past three weeks is X m/s². Accordingly, control parameter logic 308 may set an absolute maximum value of X m/s², wherein if the acceleration operational data exceeds the maximum value (either momentarily or for a predefined amount of time), the comparator circuit 316 may determine that potentially non-normal operation exists. To avoid false positives as the acceleration control parameter by itself may be inconclusive, the comparator circuit 316 may utilize other control parameters in combination with the acceleration control parameter to very or likely verify the presence of normal or non-normal operation. That is to say, the comparator circuit 316 may utilize the acceleration control parameter in combination with other pattern recognition (e.g., time of day, geolocation, etc.). As an example, if the comparator circuit 316 determines that the user is going into work and the expected acceleration is not detected, then the comparator circuit 316 may determine that the user is going into work but without their transaction card, which may be considered non-normal and trigger the one or more responses as described below. As those of ordinary skill in the art will appreciate and recognize, the precise range or thresholds used in the comparison with the operational data to indicate normal operation or non-normal operation are highly configurable and may vary from application to application.

In one embodiment, the comparator circuit 316 may be structured to make the determination of normal operation or non-normal operation based on a single piece of operational data. For example, a piece of operational data may deviate from a control parameter by more than a predefined maximum threshold to cause the comparator circuit 316 to make the non-normal operation determination. As an example, the pressure control parameter may be eighty (80) pounds-per-square inch (PSI) of pressure during commute times on Monday-Friday for a user (the relatively high pressure control parameter may be high due to the transactional card 130 being stored in a wallet of the user, where the wallet is located (typically) in the back pocket of the user. If the operational data indicates approximately zero (0) PSI during this time and the maximum threshold is plus-or-minus thirty (30) PSI relative to the pressure control parameter, the comparator circuit 316 may determine that potentially non-normal operation exists. In another embodiment, more than one piece of operational data may be used by the comparator circuit 316 in relation to the corresponding control parameters to make the determination (e.g., the temperature control parameter and pressure control parameter).

In another embodiment, the comparator circuit 316 may be structured to make the determination of normal operation or non-normal operation based on the operational data being outside the predefined threshold for a predefined duration. The predefined duration may be an amount of time (e.g., outside of the predefined deviation for more than a weeks' time, etc.). The predefined duration may be a majority of the operational data for a predefined sampling period the operational data. For example, the sampling period may comprise thirty data points per eight hour period. If sixteen of those data points are outside a predefined threshold or range for the eight hour sampling period, the comparator circuit 316 may determine a potentially undesirable event exists. Of course, those of ordinary skill in the art will appreciate that the predefined duration is a highly configurable variable that may vary from application-to-application.

In still another embodiment, the comparator circuit 316 may be structured to compare the operational data to a determined or received pattern regarding card operation and usage. In this regard, while the aforementioned examples rely on comparing one or more operational data points to one or more control parameters, the comparator circuit 316 may determine a pattern of usage based on the operational data. The “pattern”, therefore, may include a combination of data, e.g., accelerometer data, combined with time and/or location, etc. In this regard, in some embodiments, the control parameter may include the pattern of determined operation and usage of the transaction card 130. The pattern may also be provided by the user via the card management system client application 160, wherein the user may provide information used to establish patterns of usage (e.g., where they typically travel, where/when they typically use the transaction card, etc.).

In still another embodiment, the comparator circuit may be structured to compare the highest quality operational data to the corresponding control parameter or pattern of usage to determine normal or non-normal operation of the transaction card 130. For example, because there may be several sensors included with the card, the signal-to-noise ratio may impact the acquisition of accurate data. Accordingly, the comparator circuit 316 may utilize one or more algorithms, processes, formulas, filters, and the like to filter or sift out low quality (i.e., potentially inaccurate data) operational data. As such, the comparison may be based on relatively high quality operational data. For example, if the person consistently brings their card to work every day, and the person is rarely out of the office for more than a few days at a time (i.e., for either vacation or work-related travel), then the aforementioned accelerometer example may have a relatively good signal to noise ratio. But, if the person is haphazard about bringing their card into work, or if they are out of the office a lot and for unpredictable amounts of time, then the aforementioned accelerometer example may have poor signal to noise ratio. Different people have different habits, so different sensors may provide different signal to noise ratios for different people.

Accordingly, the comparator circuit 316 may be structured to determine the best signal to noise ratio, and then use that data to detect out-of-pattern situations. As an example, the sensor (or combination of sensors) that seem to provide data that repeats itself in some sort of pattern, e.g., the same thing happens at the same time every day, or repeats itself in some other fashion (the combination of inputs from certain various sensors always happen in combination) may be considered to have a high signal to noise ratio and used in the comparison.

In yet another embodiment, the comparator circuit 316 may use binding of the transaction card 130 to an object or location to determine if non-normal operation potentially exists (e.g., an object binding input and/or a geographical area binding input). For example, via the card management system client application 160, the user 101 may define a distance that transaction card must be in range of or substantially in range of the mobile device 120 and if the transaction card 130 is at a distance beyond the predefined distance, the notification circuit 318 may transmit a notification (i.e., object binding). As another example, the user 101 may define geographic coordinates indicative of normal operation for the transaction card 130 (e.g., within a predefined state, county, city, etc.). Accordingly, if the location circuit 310 determines that that transaction card 130 is outside of the predefined location for a predefined amount of time, the notification circuit 318 may transmit a notification or cause another response as described below (i.e., location binding).

Responsive to the determination of the comparator circuit 316, the notification circuit 318 may be structured to actuate one or more responses. One response may include transmitting a message to the card management system client application 160 or in general to the mobile device 120 of the user 101. The message may include, but is not limited to, an indication of the location of the transaction card 130, an inquiry to the user 101 to confirm that the transaction card 130 is not in an undesirable situation, information regarding the operational data of the transaction card, information regarding the control parameters, etc. Accordingly and as mentioned above, via the card management system client application 160, the user 101 may observe activity regarding the transaction card 130, manage control parameters, confirm/deny existence of an undesirable event, etc. As an example, as mentioned above, the card management system client application 160 may receive the message (e.g., in the mobile banking application if the client application is included with the mobile banking application), wherein receipt of the message may cause an alert on the mobile device 120, wherein the alert may include notification on the mobile device 120 including, but not limited to, a vibration, a beep, a combination of a vibration and tonal sound, and the like. The user may then resolve the alert in mobile banking or any other graphical user interface that includes the card management system client application 160. In certain configurations, a security layer may be added to this process. For example, the user may be required to provide a biometric, such as a fingerprint scan on a fingerprint scanner of their mobile device, which may be separate and apart from providing login credentials to their mobile banking client application. Such a process may provide a quick/easy way to resolve notifications about potentially non-normal operation determinations and avoiding false-positives. Further, such a process may be advantageous in case both the mobile device and transaction card go missing because a thief cannot resolve the alert may by logging onto online banking with stored credentials on the mobile device; rather, the thief may be required to provide the correct fingerprint scan on the mobile device. Therefore, such a process may reduce fraudulent activity with respect to a stolen transaction card 130.

As described above, via the card management system client application 160, the user may provide information to determine a pattern of usage and operation for the user of the transaction card 130. In a similar manner, the notification circuit 318 may provide information to the card management system client application 160 to resolve a potentially non-normal operation determination. For example, if the card management system 190 determines non-normal operation (e.g., lost), the system 190 may provide a message like “Do you have the card in your possession? Yes or No?” If the user answers no, then the follow-up question might be “what is the likelihood you lost or misplaced your card? Low, medium or high?” This may even be done through a text message interface. Based on those user inputs, the system 190 may then decide how much to limit access to the card (e.g., Low=heightened fraud monitoring, the card cannot be used for single transactions over $1000 (i.e. the user can't buy a new flat screen TV at best buy), but otherwise the card can be used as normal; Medium=heightened fraud monitoring, the card cannot be used for single transactions over $100 (i.e. the user can only use the card for basic every day purchases), and geographic/other restrictions are placed on card usage; High=the card is deactivated and the user is sent a new card). If the user answers low or medium, the user may also be told to let the bank/financial institution know if they find their card, and the bank/financial institution will restore the card to its full operability.

In regard to what exactly happens based on whether the user responds “low” “medium” or “high”, the card management system 190 may set or facilitate setting (e.g., via communications to the enterprise computing system 142) the spending limits automatically based on the user's typical transaction patterns (this response is described below in regard to affecting usage of the transaction card). Such a process may also be achieved through an area of online banking where the user is told what all their defaults are for each of these choices, and then given the ability to manually override them. This may be important to the extent that there are other restrictions (e.g., geographic) on the transaction card. For example, the user may know that they tend to travel all over the place for work, and so that they don't ever want any geographic restrictions placed on card usage. Or, maybe the user knows that they have transaction cards with several different banks, so not being able to use one temporarily is not a big deal because they have others they can use. So, even a “low” probability kicks in a lot of restrictions on card usage, or even temporarily deactivates the card (without send them a new one) until the current card is found. Also, all or mostly all of these settings may be updated by the user after the card is (temporarily) lost. As an example, the user may get a text message about their card potentially being lost. The user may respond that it could be lost, but then they go into online banking (which the client application 160 is a part of) to customize what they want to happen, taking into account their plans for the next few days. At which point, the card management system 190 may generate and provide some option that the user selects which says “these are temporary settings for the next X days. If you don't hear from me in X days, or if the on-board card technology does not determine that the card has been found before then, then deactivate the card, send me a new card, and revert to the original settings.”

As alluded to above, another such response may be affecting usage of the transaction device. For example, responsive to a determination by the comparator circuit 316 that the operational data is outside a predefined range of the control parameter, the notification circuit 318 may provide a message to the enterprise computing system 142 to control at least one of a spending limit of the card 130 (e.g., limit it to fifty dollars ($50) where the previous maximum was twenty-five hundred dollars ($2500)), limit where the card 130 may be used (e.g., the card was able to be used at all terminals with a compatible point-of-sale reader and now is only useable at one or more predefined locations or merchants, such as a gas station and a grocery store), and in certain instances deactivate or cancel the card 130 entirely. In another embodiment, the transaction circuit 314 directly may provide such controls over the transaction device 202 itself and thereby alleviate the intermediary (i.e., enterprise computing system 142). Such a configuration may facilitate relatively faster transaction controls being effectuated.

Another such response may be causing the issuance of a new transaction card responsive to a determination that the transaction card 130 is experiencing non-normal operation, such as being lost. Performance of such an action may be based on the user 101 providing an affirmative answer that he/she cannot locate the transaction card 130 (or, in an alternate embodiment, may be triggered automatically). In one embodiment, causing issuance of a new transaction card may be based on the operational data indicating that the transaction card 130 is outside the predefined location or outside of the range of the bounded object, such as the mobile device 120. In other words, causing issuance of a new transaction card may be based on the operational data indicating that the transaction card 130 is at least one of outside of a predefined acceptable geographical area and outside of a maximum distance from a bound object. In this regard, this example data may be more likely than not to indicate a lost or stolen transaction card.

In some embodiments, the notification may be based on the type of operational data outside of the control parameter. For example, as alluded to above, if the location data indicates that the transaction card is outside a predefined bounded location, one response may be causing issuance of a new card while another response may be an email and a text message. As another example, if the temperature data is outside of the temperature control parameter, the notification circuit 318 may only cause transmission of a text message. Thus, as those of ordinary skill in the art will appreciate, the type and content of the notification may vary greatly based on the determination of the comparator circuit 316.

In some other embodiments, the notification may be based on the relative deviation of one or more pieces of operational data from the predefined range or threshold for the corresponding control parameter. For example, the temperature control parameter may be seventy (70) degrees Fahrenheit plus-or-minus twenty (20) degrees Fahrenheit on Monday-Friday from 9am to 5pm. If the temperature of the transaction card is seventy-five (75) degrees, the notification circuit 318 may not transmit a notification. If the temperature of the card is ninety-one (91) degrees, the notification circuit 318 may transmit a text message to the mobile device associated with the user of the card to confirm normal operation of the transaction card. If the temperature of the reaches one-hundred (100) degrees, the notification circuit 318 may transmit text message, deactivate the transaction card, and cause issuance of a new card. For example, due to this temperature, some components within the transaction card may become degraded, such that the card management system 190 is proactively avoiding such an unwanted result that may hinder performance.

As those of ordinary skill in the art will appreciate, the precise delineations of when one or more of the aforementioned responses is highly configurable based on the application. For example, some users or enterprise systems may designate a predefined response of cancelling or deactivating the card 130 if it is outside a distance to a bound object (e.g., mobile device 120) or geographic area for more than a predefined amount of time. As another example, based on the biometric data indicating five or more uses or attempted uses of the transaction card 130, the transaction circuit 312 may limit the spending limit and useable locations for the transaction device 202. As yet another example, based on at least one of the temperature and pressure operational data being outside the predefined range or threshold at a certain time and location, the notification circuit 318 may transmit a message (e.g., email, text message, etc.) to the mobile device 120 of the user to check the status of the transaction card 130. In some configurations, two or more responses may be used based on the comparison performed by the comparator circuit 316.

Based on the foregoing an example operation may be described as follows. Via the card management system client application 160, the user 101 may bind the transaction card 130 to the mobile device with a distance of ten (10) feet and set a geographic area of the residing state of the user 101. Contemporaneous or subsequent to, the card management system 190 may acquire operational data regarding the transaction card 130. From the operational data, the card management system 190 may determine one or more control parameters corresponding to one or more pieces of the operational data (e.g., a temperature control parameter at certain times/locations based on the temperature operational data). At some point in the future, if the operational data is outside the predefined range of the control parameter or the transaction card 130 is outside the bound distance to the mobile device 120 or outside of the residing state of the user 101, one or more responses may be actuated by the card management system 190. For example, if the location of the transaction card 130 indicates that it is fifteen (15) feet from the mobile device 120 (using the GPS coordinates of the mobile device 120), a text message may be provided to the mobile device 120 to ensure or substantially ensure that the card has not been lost or stolen. If, however, the location of the transaction card 130 is outside the residing state, a text message may be provided and the transaction card 130 cancelled. In this instance, a user may program the card management system 190 to respond swiftly at instances that are likely to correspond with a lost or stolen transaction card. However, if the other operational data indicates non-normal usage, the card management system 190 may just provide a notification to the mobile device 120 of the user because there may be a relatively greater possibility that the card is not stolen or missing.

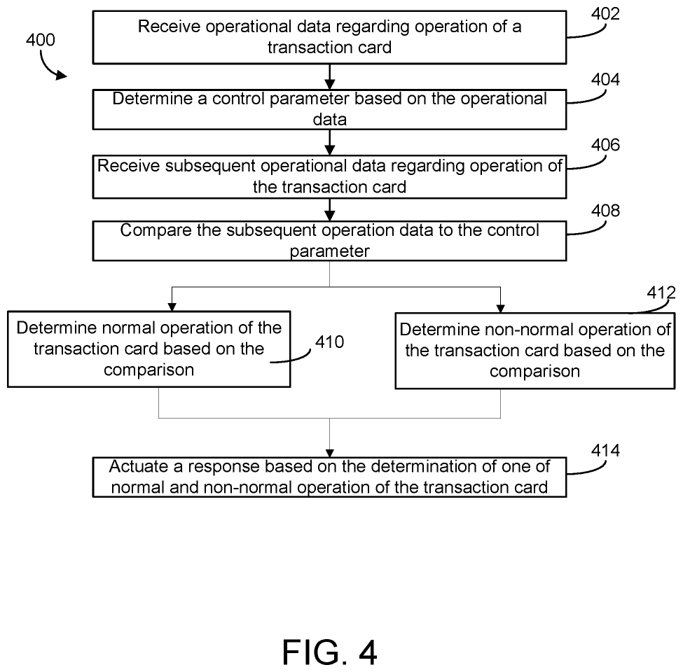

Referring now to FIG. 4, a process of tracking a transaction card via the card management system of FIGS. 1-3 is shown, according to an example embodiment. Because the process 400 may be implemented with the card management system 190 of FIGS. 1-3, reference may be made to various components of the card management system 190 to aid explanation of process 400.

At process 402, operational data regarding operation and usage of a transaction card is received. The operational data may include, but is not limited to, transactional data (e.g., merchant codes, transaction amounts at various locations and times, etc.) and other operational data (e.g., temperature data at various locations and times, pressure data at various locations and times, biometric data, acceleration data, etc.). The operational data may be acquired or received by the sensor circuit 310 of the card management system 190.

At process 404, a control parameter for the transaction card is determined based on the operational data. As mentioned above, the control parameter may be a range or threshold indicative of normal operation of the transaction card. The control parameter may be based on one or more pieces of the operational data based on a confidence level associated with the control parameter. For example, if the operational data is always changing with respect to the temperature operational data, a control parameter may not be determined for the temperature data. As mentioned above, achieving the confidence level may be based on the corresponding operational data being acquired for a predefined amount of time, wherein such passage of time may facilitate the acquisition of relatively more accurate data.

As mentioned above, the control parameter may also be location-based, wherein the location-based control parameter may be received from at least one of the user via the card management system client application 160 or from an entity associated with the enterprise computing system 142. The location-based control parameter may bind the transaction card 130 to an object, such as a mobile device 120 (e.g., to be within a certain distance of the mobile device 120 before a determination of an undesirable event is made). The location-based control parameter may also confine the transaction 130 to a geographic area (e.g., county lines, a state, an area code, etc.), wherein if the transaction data indicates that the transaction card 130 is outside the geographic area one or more responses may be generated and provided as described below.

In combination with receiving or determining the control parameter, process 404 may also include assigning the control parameter a predefined range or assigning an acceptable threshold to the control parameter (e.g., a maximum or a minimum value). In this regard, if subsequent operational data (process 406) is determined to fall above the minimum threshold, below the maximum threshold, or within the predefined range, the card management system 190 may determine normal operation of the transaction card 130. The value assigned as the maximum threshold, minimum threshold, or value with the predefined range may be a maximum value received of the corresponding operational data for a past predefined time period (e.g., in regard to assigning a maximum threshold value), a minimum value received for the corresponding operational data for the past predefined time period (e.g., in regard to assigning a minimum threshold value), an average value of the operational data received for the past predefined time period (e.g., in regard to assigning a predefined range to the average value), a median value of the operational date received for the past predefined time period (e.g., in regard to assigning a predefined range to the median value), a user-specified range, and so on.

As mentioned above, the control parameter may also be a pattern of normal operation and usage of the transaction card, which may be based on an initial acquisition of operational data. In another embodiment, the pattern may be based on information provided by the user (e.g., elicited through a series of questions).

At process 406, subsequent operational data regarding the usage and operation of the transaction card is received. The subsequent operational data may include the transaction data, the other aforementioned operational data (e.g., temperature data), and location data. In this regard, the card management system may monitor operation and usage of the transaction card 130.

At process 408, the subsequent operational data is compared to the control parameter. In one embodiment, the comparison may be for one sampling point of operational data (e.g., the most recently received data). In another embodiment, the comparison may be based on an average or median value of the subsequent operational data received or acquired for a past defined time period. In yet another embodiment, the comparison may be based on any value that may be representative of the subsequent operational data. In still another embodiment, the subsequent operational data may be analyzed to determine a pattern of behavior wherein that pattern of behavior is then compared to a determined or received pattern of behavior for the user. In this regard and as mentioned above, multiple control parameters may be used that are indicative of a pattern of usage for the user in making the comparison.

At process 410, normal operation of the transaction card is determined responsive to the comparison. The card management system 190 may determine normal operation and usage of the transaction card based on the subsequent operational data falling with the predefined range, below the predefined maximum threshold, or above the predefined minimum threshold (i.e., at the comparison process 408). For example, if the location data is indicative that the transaction card 130 is within the predefined range of the mobile device 120. The determination of normal operation may be based on a single operational data point indicating normal operation, a majority of operational data points indicating normal operation, all of the operational data point indicating normal operation, etc. Further, the determination of normal operation may be based any of the following existing for a predefined duration (e.g., momentarily, for the past X timeframe, etc.). Moreover, the determination may be based on any combination of above.

At process 412, non-normal operation is determined based on the comparison. Process 412 may be substantially similar to process 410 except that the operational data indicates that non-normal operation potentially exists, such as a lost, missing, or stolen transaction card. In this regard and as indicated by the comparison, the subsequent operational data may fall outside of the predefined ranged, below the minimum threshold value, above the maximum threshold value, etc.

At process 414, a response is actuated based on a determination of one of normal operation and usage of the transaction card and potentially non-normal operation and usage of the transaction card. As mentioned above, the response may include a message (e.g., text message, email, SMS, etc.) including information indicative of the determination (e.g., processes 410-412), such as a location of the transaction card to help a user locate the transaction card if it has become missing. The response may also include a message asking the user to confirm that the transaction card is missing or not missing. The response may also include limiting the activity of the transaction card (e.g., lowering a spending limit, limiting which locations may accept the card, etc.). In some embodiments, the response may further include deactivating the card and causing issuance of a new transaction.

As mentioned above, the precise response may be highly configurable. For example, the response may be an update indicating that everything appears normal when the determination is normal activity. However, in regard to potentially non-normal operation, the response options may vary greatly based on the comparison. As an example, if the subsequent temperature data is only slightly outside of the temperature control parameter (e.g., five degrees Fahrenheit outside a range or another value that may be considered slight by those of ordinary skill in the art). In this instance, the response may be a message to a mobile device of the user asking the user to confirm or deny normal operation of the transaction card. However, if the subsequent temperature control data is significantly outside of the temperature control parameter (e.g., thirty degrees Fahrenheit outside the range or another value that may be considered significant by those of ordinary skill in the art), the response may be a message to the user and additionally limiting the use of the transaction card. As another example, if the location data indicates that the transaction card is outside the predefined geographic area for more than a predefined amount of time, the response may be cancelling the transaction card and issuance of a new card. As such, those of skill in the art will appreciate that this list is not meant to be limiting and the present disclosure contemplates many different response strategies that may be implemented.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. An apparatus, comprising:
a sensor circuit structured to receive initial operational data and subsequent operational data following the initial operational data, the initial and subsequent operational data indicative of real-time operation and usage during one or more transactions of a transaction card, and wherein the initial and subsequent operational data comprises a biometric characteristic associated with the transaction card;
a control parameter circuit structured to:
determine a control parameter responsive to the initial operational data, the control parameter indicative of normal operation of the transaction card;
receive an indication that the determined control parameter is at least partly incorrect and
update the determined control parameter based on user information provided via a user interface to correct the determined control parameter;
a location circuit structured to determine a location of the transaction card;
a comparator circuit structured to:
compare the subsequent operational data to the updated control parameter; and
responsive to the comparison, determine the subsequent operational data is indicative of one of normal operation of the transaction card and non-normal operation of the transaction card; and
a notification circuit structured to provide one or more responses responsive to the determination,
wherein responsive to determining non-normal operation, the notification circuit is structured to implement one or more responses based on a gradation of deviation between the subsequent operational data and the initial operational data, the one or more responses comprising at least one of:
limiting usage of the transaction card by lowering a spending limit of the transaction card,
limiting usage of the transaction card to only a predetermined location, and
providing an alert to a mobile device associated with a user in response to the location of the transaction card exceeding a predefined distance from the mobile device.

2. The apparatus of claim 1, further comprising:
a transaction circuit operatively and communicably coupled to a transaction device of the transaction card, the transaction circuit structured to acquire transaction data regarding operation of the transaction device, the transactional data useable by the control parameter circuit to determine the control parameter and by the comparator circuit to determine the one of the normal operation of the transaction card and the non-normal operation of the transaction card.

3. (canceled)

4. (canceled)

5. The apparatus of claim 1, wherein responsive to the location of the transaction card indicating the transaction card is outside of a defined geographical area, the notification circuit is structured to transmit a message to the mobile device associated with the user and limit usage of a transaction device of the transaction card.

6. (canceled)

7. The apparatus of claim 5, wherein the limited usage of the transaction device includes cancellation of the transaction card and causing issuance of a new transaction card.

8. The apparatus of claim 1, wherein responsive to the location of the transaction card indicating the transaction card exceeds the predefined distance from the mobile device for more than a predefined duration, the notification circuit is structured to provide a message to the mobile device requesting the user to confirm or deny normal operation regarding the transaction card.

9. A method, comprising:
receiving, by a transaction card, a control parameter indicative of normal operation of a transaction card;
determine that the control parameter is at least partly incorrect and
update the determined control parameter based on user information provided via a user interface to correct the control parameter;
acquiring, by the transaction card, operational data regarding operation and usage of the transaction card, wherein the operational data includes location data indicative of a location of the transaction card, a biometric characteristic associated with the transaction card, and other real-time operation and usage data regarding the transaction card during one or more transactions of the transaction card;
comparing, by the transaction card, the operational data to the updated control parameter;
responsive to the comparison, determining, by the transaction card, one of normal operation and non-normal operation of the transaction card;
causing, by the transaction card, one or more responses based on the determination of the non-normal operation, the one or more responses based on a gradation of deviation between the operational data and the control parameter, the one or more responses comprising at least one of:
providing an alert to a mobile device of a user associated with the transaction card in response to the location of the transaction card exceeding a predefined distance from the mobile device
limiting usage of the transaction card by lowering a spending limit of the transaction card, and
limiting usage of the transaction card to only a predetermined location.

10. (canceled)

11. The method of claim 9, wherein the operational data includes at least one of a temperature of the transaction card and a pressure applied to the transaction card.

12. The method of claim 9, further comprising determining the non-normal operation of the transaction card based on the operational data differing from the control parameter by more than a predefined acceptable amount.

13. The method of claim 9, further comprising determining the normal operation of the transaction card based on the operational data being within a predefined range of the control parameter.

14. The method of claim 9, wherein at least one of the one or more responses includes cancelling the transaction card and causing issuance of a new transaction card.

15. A transaction card, comprising:
memory having instructions stored therein; and
at least one processor configured to:
determine a control parameter, the control parameter indicative of normal operation of the transaction card;
receive an indication that the determined control parameter is at least partly incorrect
update the determined control parameter based on user information provided via a user interface to correct the determined control parameter;
acquire operational data regarding operation of the transaction card, the operational data including a location of the transaction card, a biometric characteristic associated with the transaction card, and other real-time operation and usage data regarding the transaction card during one or more transactions of the transaction card;
compare the operational data to the updated control parameter;
responsive to the comparison, determine one of normal operation and non-normal operation of the transaction card;
selectively causing one or more responses based on the determination of the non-normal operation, wherein the one or more responses are based on a gradation of variation between the operational data and the control parameter, the one or more responses comprising at least one of:
providing an alert to a mobile device of a user in response to the location of the transaction card exceeding a predefined distance from the mobile device;
limiting usage of the transaction card by lowering a spending limit of the transaction card; and
limiting usage of the transaction card to only a predetermined location.

16. The transaction card of claim 15, further comprising a sensor, the sensor including at least one of a temperature sensor, a pressure sensor, a biometric sensor, and an accelerometer, wherein the sensor is structured to acquire the operational data.

17. The transaction card of claim 16,
wherein the operational data includes at least one of a temperature of the transaction card, a pressure on the transaction card, a biometric characteristic of the transaction card, and an acceleration characteristic of the transaction card; and
wherein the control parameter corresponds to the operational data such that the control parameter includes at least one of a temperature control parameter at a certain location and at a certain time, a pressure control parameter at a certain location and at a certain time, an acceleration control parameter at a certain location and at a certain time, and a biometric control parameter at a certain location and at a certain time.

18. The transaction card of claim 17, wherein the at least one processor is further configured to determine the non-normal operation responsive to the comparison indicating the operational data is one of outside a predefined acceptable range, below a minimum threshold, or above a maximum threshold for the control parameter.

19. (canceled)

20. The transaction card of claim 18, wherein responsive to the non-normal operation determination, the at least one processor is further configured to cancel the transaction card and facilitate issuance of a new transaction card.
